(19) United States
(12) Patent Application Publication
(10) Pub. No.: US 2021/0143516 A1
(43) Pub. Date: May 13, 2021

(54) LEAD-ACID BATTERY AND BATTERY PACK

(71) Applicant: TIANNENG BATTERY GROUP CO., LTD., Zhejiang (CN)

(72) Inventors: Guoyou HOU, Zhejiang (CN); Tianren ZHANG, Zhejiang (CN); Haimin ZHAO, Zhejiang (CN); Wenwei ZHOU, Zhejiang (CN); Mingxue FANG, Zhejiang (CN); Genfang GAO, Zhejiang (CN); Yuenan LI, Zhejiang (CN); Fei DAI, Zhejiang (CN); Xiaoqun GUO, Zhejiang (CN); Shu HU, Zhejiang (CN)

(73) Assignee: TIANNENG BATTERY GROUP CO., LTD., Zhejiang (CN)

(21) Appl. No.: 16/325,724

(22) PCT Filed: May 23, 2017
(86) PCT No.: PCT/CN2017/085430

§ 371 Date: Feb. 15, 2019

(30) Foreign Application Priority Data
Dec. 9, 2016 (CN) 201611135932.2

(51) Int. Cl. H01M 50/552; H01M 10/14; H01M 50/51

(52) U.S. Cl. CPC H01M 50/561; H01M 50/51; H01M 10/14

(57) ABSTRACT

A lead-acid battery includes a container and an intermediate cover. The container comprises six pole groups in linear arrangement in a longitudinal direction. Two of the pole groups on a farthest edge are provided with pole posts penetrating through the intermediate cover. The intermediate cover is fixed with two connection terminals. Each of the connection terminals comprise a first connecting part connected to the pole post and a second connecting part connected to an external wire. The two connection terminals are provided on a side of the intermediate cover in a width direction of thereof, and the second connecting part is led out from a side surface of the intermediate cover. One of the connection terminals is directly connected to one of the pole posts, and the other one of the connection terminals is connected to another one of the pole posts via an adapted cable.

### BACKGROUND

### Field of the Invention

The present invention is related to a lead-acid battery, in particular to a horizontal lead-acid battery and a battery pack that are easy for wiring.

### Background Arts

Lead-acid battery is the most important dynamic power for electric bicycle at present, which features in low price and high safety as compared with lithium-ion battery. As the voltage and capacity of a single battery are unable to satisfy usage requirements of the electric bicycle, generally, numerous batteries are connected in series to form a battery pack as placed inside a battery box. In a normal state, a storage battery is placed vertically (the pole plate is upright); however, a long-term usage of the storage battery may result in layering of acid liquid and make the storage battery lose efficacy. As indicated by studies, horizontal storage battery (pole plate is horizontally placed) can effectively solve such problem and extend service life of the battery.

For instance, Chinese Patent application No. CN102222803A discloses a 12V valve-controlled type narrow and enclosed lead-acid battery of high-temperature circulation that can be applied to cabinets while maintaining its long cycle life in a severe high-temperature electrical application environment. By taking 2V as a pole group, it is provided with 6 pole groups in series connection. Positive and negative pole plates inside the pole groups are horizontally placed. The 6 pole groups are overlapped vertically in the form of 1×6; storage battery pole groups are arranged with tabs opposite to each other diagonally; positive pole post and negative pole post are led out from upper and lower parts of a front end of the storage battery respectively.

For further instance, Chinese Utility Patent No. CN203967209U discloses a 12V horizontal lead-acid battery with capacity of 100 Ah or below. 6 pole group mounting grooves are arranged horizontally. A battery cover is vertically arranged and fixed with the pole group mounting grooves. Numerous pole plates in each pole group are sequentially and horizontally overlapped. The pole groups are sequentially installed inside the pole group mounting grooves correspondingly. 6 bus bars are provided between the pole groups and the battery cover. The pole groups and the bus bars are in one-to-one correspondence to a safety valve. The bus bars are fixedly connected to each pole plate. Two output terminals are provided on a top surface of the battery cover. Two pole posts are disposed on an exterior wall of the battery cover.

It can be seen that connection terminal of the traditional horizontal storage battery is provided on the top surface of the battery cover, and is to be on a lateral side of the storage battery during use due to horizontal placement. As a top portion of the battery cover for the electric bicycle is normally an opened structure, it is difficult for wiring of the horizontal battery inside the battery box, which may remain a gap; this may result in violent swing of the battery to the extent of affecting its service life.

### SUMMARY OF THE INVENTION

The present invention provides a horizontal lead-acid battery that is easy for wiring to solve the problem with wiring of the traditional horizontal lead-acid battery inside the battery box.

A lead-acid battery includes a container and an intermediate cover. The container comprises 6 pole groups in linear arrangement in a longitudinal direction. Two of the pole groups on a farthest edge are provided with pole posts penetrating through the intermediate cover. The intermediate cover is fixed with two connection terminals. The connection terminals comprise a first connecting part connected to the pole post and a second connecting part connected to an external wire. The two connection terminals are provided on a side of the intermediate cover in a width direction thereof. The second connecting part is led out from a side surface of the intermediate cover. One of the connection terminals is directly connected to one of the pole posts, and the other one of the connection terminals is connected to another one of the pole posts via an adapter cable.

The container is normally an oblong structure with numerous unit cells used to contain pole groups. The lead-acid battery according to the present invention only refers to the structure of 1×6 unit cells other than 2×3 ones. The longitudinal direction refers to a direction parallel to a long side of the container. The width direction refers to a direction parallel to a short side of the container. Same definition is also applicable to the intermediate cover.

As the pole groups are arranged in the longitudinal direction of the container, and only the two of the pole groups on the farthest edge are provided with pole posts for connection with the connection terminals, to locate the two connection terminals on the side in the width direction of the intermediate cover, one of the connection terminals is directly connected to one of the pole posts; whereas the other one of the connection terminals is connected to another one of the pole posts via the adapter cable to change positions of the connection terminals.

The second connecting part is led out from the side surface of the intermediate cover, which aims to change the side surface of the intermediate cover into a top surface of the battery during use, so as to facilitate wiring.

In a preferred embodiment, the connection terminals comprise a terminal body and a connecting plate. The intermediate cover is provided with a rubber tank used to fix the connecting plate and a locating slot fitting with the terminal body. The locating slot is provided with an opening on the side surface of the intermediate cover that leads out the second connecting part.

In a preferred embodiment, the terminal body is cylindrical with an end portion thereof provided with a threaded connecting hole.

In a preferred embodiment, the opening is provided with a colored ring sleeved on the terminal body.

In a preferred embodiment, the colored ring is provided with a flange; an inner wall of the locating slot is provided with an engaging groove fitting with the flange.

In a preferred embodiment, the rubber tank and the locating slot are separated by a separator; and the connecting plate is provided with a bridge across the separator.

In a preferred embodiment, a top surface of the intermediate cover corresponding to positions for connection of the pole posts and the connection terminals, connection of the pole posts and the adapter cable, as well as connection of the adapter cable and the connection terminals is provided with a rubber tank.

In a preferred embodiment, a top surface of the intermediate cover is provided with a wiring groove for burying the adapter cable.

In a preferred embodiment, the second connecting part is provided with a through-hole for connection with the adapter cable or the pole posts.

In a preferred embodiment, the lead-acid battery comprises a protective cover covering whole of a top surface of the intermediate cover, and an isolation slot fitting with the connection terminals is provided on a lateral side of the protective cover.

In a preferred embodiment, the protective cover and the intermediate cover are connected in snap fit connection.

In a preferred embodiment, two sides of the container in the width direction have a slope, and are provided with a rod used to compensate the slope.

In a preferred embodiment, the intermediate cover is provided with a row of injection holes corresponding to the pole groups; and the injection holes are deviated from a center of the pole groups in a direction adjacent to the connection terminals.

The present invention further provides a battery pack composed of the lead-acid batteries in series connection. During use, the pole groups are placed horizontally, the second connecting part of the connection terminals is led out from a top surface of the lead-acid battery, adjacent batteries tightly contact each other; and the connection terminals are connected via a connector.

The adapter cable of the lead-acid battery according to the present invention transfers one of the connection terminals to the same side of another one of the connection terminals, and the connecting part of the connection terminals connected to the external wire is led out from the side surface. When the battery is placed horizontally during use, the connection terminals are on the top surface of the battery to facilitate wiring.

### DESCRIPTION OF DRAWINGS

FIG. 1 is a structural diagram of a lead-acid battery according to the present invention.

FIG. 2 is an exploded view of the lead-acid battery according to the present invention.

FIG. 3 is a partial structural diagram of a connection terminal of the lead-acid battery according to the present invention.

FIG. 4 is a structural diagram of the lead-acid battery according to the present invention without a protective cover.

FIG. 5 is a structural diagram for a container.

FIG. 6 is a perspective structural diagram of an intermediate cover.

FIG. 7 is a structural diagram for the top structure of the intermediate cover.

FIG. 8 is a sectional diagram of the intermediate cover taken along line A-A shown in FIG. 7.

FIG. 9 is a structural diagram of the connection terminal.

FIG. 10 is a structural diagram of the protective cover.

FIG. 11 is a sectional diagram of the protective cover shown in FIG. 10.

FIG. 12 is a structural diagram of a battery pack according to the present invention.

### PREFERRED EMBODIMENTS

As shown in FIGS. 1-2, a horizontal lead-acid battery includes a container 1, an intermediate cover 2, and a protective cover 3; those three parts constitute a battery box with an oblong structure. As shown in FIG. 5, a compartment is provided inside the container 1 to separate an internal cavity into a plurality of unit cells 12. A step 13 fitting with the intermediate cover is provided at a position adjacent to a port of the container 1 to make a surface of the battery box flat after assembly. Since the container is relatively high in depth, two sides of the container 1 in the width direction are provided with a slope that is 0.3-0.5°. To compensate such slope, the two sides are provided with a plurality of diagonal rods 11. The disposition of the diagonal rods 11 can enhance the strength of the container; moreover, when the battery box tightly contacts a plane, a vent is formed among such diagonal rods to facilitate heat dissipation.

As shown in FIG. 5, the unit cells 12 inside the container are arranged in a pattern of 6×1; each unit cell 12 contains the pole groups (not indicated in the figures). The pole groups are normally composed of overlapped positive pole plates, negative pole plates, as well as separators. A top portion of the pole groups is provided with bus bars and pole posts. During assembly of the batteries, the bus bars of the adjacent pole groups are connected so as to connect all of the pole groups in series. The pole groups on two outmost edges are provided with a pole post respectively. The two pole posts will penetrate through pole post hole 28 on the intermediate cover 2 for connection with connection terminals 4 fixed to the intermediate cover 2.

As shown in FIG. 4, the intermediate cover 2 is fixed with two connection terminals 4. A pole post of the traditional battery penetrates the intermediate cover and is directly connected with the connection terminals. However, the present invention does not adopt this design. One of the connection terminals is directly connected to one of the pole posts, and the other one of the connection terminals is connected to the pole post via an adapter cable 5, so that the two connection terminals can be transferred to the side in the width direction of the intermediate cover 2. Connection between the pole post and the connection terminal, connection between the pole posts and the adapter cable 5 as well as connection between the connection terminal and the adapter cable are all realized by means of welding. It can be seen clearly from the figures that each welding point is wrapped with insulating adhesive for sealing.

To further understand assembly mode of the connection terminals, please refer to FIGS. 6-8. A top surface of the intermediate cover 2 is provided with three rubber tanks 20, 21 and 22. Positions where the rubber tanks 20, 22 situate are both provided with the pole post hole 28. One of the pole posts penetrates through the pole hole 28 for direct connection with the connection terminal, and the other one of the pole posts penetrates through the pole hole for connection with another connection terminal via the adapter cable 6. It is applicable to cover all of the welding points through dispensing glue inside the rubber tank; moreover, it is also applicable to fix the connection terminal 4 and an end portion of the adapter cable.

As shown in FIG. 9, the connection terminal 4 comprises a connecting plate 42 and a terminal body 41. The terminal body 41 is in cylindrical structure, of which one end is connected to the connecting plate 42 by means of bead welding, and an end surface of the other end of the terminal body 41 is provided with a threaded connecting hole 45. An end portion of the connecting plate 42 is provided with a through-hole 43 fitting with the pole posts or the adapter cable 5.

As shown in FIG. 6, locating slots 23, 24 fitting with the terminal body 41 are provided at an adjacent area of the rubber tanks 21, 22. The locating slots 23, 24 are provided with an opening on the side of the intermediate cover 2 where the connection terminal is located. The terminal body 41 is led out from this opening for connection with an external wire. As shown in FIG. 3, a colored ring 6 is provided at the opening to indicate polarities of the connection terminals. A flange is provided on an edge of the colored ring 6 for fixture thereof, and an engaging groove 45 is provided on an interior wall of the locating slot. When assembly, the colored ring 6 is sleeved on the terminal body 41, and the flange engages into the engaging groove 45. To facilitate installation of the connection terminals, a positioning block 211 is provided in the rubber tank 21 to prevent the connection terminals from deviating from the installation positions. The rubber tank and the locating slot are separated by a separator to prevent overflowing of glue. The connecting plate 42 of a corresponding one of the connection terminals 4 is provided with an arched bridge 44 across the separator. To prevent deviation of the connection terminals when installation, the positioning block 211 used to locate the connecting plate 42 is provided inside the rubber tank 21.

As shown in FIG. 8, the top surface of the intermediate cover 2 is provided with a wiring groove 29 used for burying the adapter cable 5, to prevent the adapted cable 5 from hindering the assembly of the batteries. Furthermore, a tab slot 26 is provided at a middle position of the intermediate cover 2. A countersink 261 is provided inside the tab slot 26. A bottom surface of the countersink 261 is provided with a pore column 262, and a center of the pore column 262 is provided with an injection hole 263. A bottom surface of the tab slot 26 is provided with a vent groove 264 in communication with each countersunk 261. The number of the injection holes is also six, and the injection holes are in one-to-one correspondence to the unit cells 12 inside the container 1. The lead-acid battery according to the present invention is also in horizontal structure. The injection hole is not aligned with a center position of the unit cell, but deviates in a direction adjacent towards the connection terminals 4. As each unit cell may have free electrolyte to some extent, such setting can prevent the electrolyte from flowing out of the injection hole to the maximum extent. A safety valve covered with a tab 7 is to be installed on a top end of each pore column 262 after injection; and the tab 7 is normally fixed by means of ultrasonic welding.

As shown in FIGS. 10-11, the protective cover 3 is mainly used for protection. The intermediate cover 2 is also provided with a step structure fitting with an edge of the protective cover 3. The step structure is provided with a projecting block 27. A buckle groove is provided on a side of the projecting block 27. An inverted buckle 32 is provided on a corresponding inner side of the protective cover 3. Furthermore, one side of the protective cover 3 is provided with a make-way slot 31; the make-way slot 31 is fitted with the locating slots 23, 24 to enclose the terminal body 41 and the colored ring 6.

As shown in FIG. 12, a battery pack includes four lead-acid batteries in parallel arrangement. Adjacent lead-acid batteries are tightly contact each other, and connected via a connector 8. The connector 8 is fixed via a screw 9 inserted into the threaded connecting hole 45. When the battery pack is in use, an outlet end of the connection terminal is located on the top surface of the battery. The protective cover 3 is located on a lateral surface of the battery to ensure horizontal placement of the pole groups, which can prevent invalidity of the battery as incurred by layering of acid liquid, and extend its service life. Moreover, the connection terminals located on the top surface of the battery can also facilitate wiring.

1. A lead-acid battery, comprising a container and an intermediate cover; the container comprises six pole groups in linear arrangement in a longitudinal direction thereof; two of the pole groups on a farthest edge are provided with pole posts penetrating through the intermediate cover; the intermediate cover is fixed with two connection terminals; each of the connection terminals comprise a first connecting part connected to the pole post and a second connecting part configured to be connected to an external wire, wherein the two connection terminals are provided on a side of the intermediate cover in a width direction thereof, and the second connecting part is led out from a side surface of the intermediate cover; one of the connection terminals is directly connected to one of the pole posts; and the other one of the connection terminals is connected to another one of the pole posts via an adapter cable.

2. The lead-acid battery according to claim 1, wherein each of the connection terminals comprise a terminal body and a connecting plate; the intermediate cover is provided with a rubber tank used to fix the connecting plate and a locating slot fitting with the terminal body; the locating slot is provided with an opening on the side surface of the intermediate cover that leads out the second connecting part.

3. The lead-acid battery according to claim 2, wherein the terminal body is cylindrical with an end portion thereof provided with a threaded connecting hole.

4. The lead-acid battery according to claim 2, wherein the opening is provided with a colored ring sleeved on the terminal body.

5. The lead-acid battery according to claim 4, wherein the colored ring is provided with a flange; an inner wall of the locating slot is provided with an engaging groove fitting with the flange.

6. The lead-acid battery according to claim 2, wherein the rubber tank and the locating slot are separated by a separator; the connecting plate is provided with a bridge across the separator.

7. The lead-acid battery according to claim 1, wherein a top surface of the intermediate cover corresponding to positions for connection of the pole posts and the connection terminals, connection of the pole posts and the adapter cable, as well as connection of the adapter cable and the connection terminals is provided with a rubber tank.

8. The lead-acid battery according to claim 1, wherein a top surface of the intermediate cover is provided with a wiring groove for burying the adapter cable.

9. The lead-acid battery according to claim 1, wherein the second connecting part is provided with a through-hole for connection with the adapter cable or the pole posts.

10. The lead-acid battery according to claim 1, further comprising a protective cover covering whole of a top surface of the intermediate cover, and an isolation slot fitting with the connection terminals is provided on a lateral side of the protective cover.

11. The lead-acid battery according to claim 1, wherein the protective cover and the intermediate cover are in snap fit connection.

12. The lead-acid battery according to claim 1, wherein two sides of the container in the width direction have a slope, and are provided with a rod used to compensate the slope.

13. The lead-acid battery according to claim 1, wherein the intermediate cover is provided with a row of injection holes corresponding to the pole groups; the injection holes are deviated from a center of the pole groups in a direction adjacent to the connection terminals.

14. A battery pack, composed of the lead-acid batteries connected in series according to claim 1, during use, the pole groups are placed horizontally; the second connecting part of the connection terminals is led out from a top surface of the lead-acid battery, adjacent lead-acid batteries tightly contact each other; and the connection terminals are connected via a connector.
